(19) United States
(12) Patent Application Publication
(10) Pub. No.: US 2024/0317357 A1
(43) Pub. Date: Sep. 26, 2024

(54) Pedal cycle apparatus

(71) Applicant: Jack Klopfenstein, Brodhead, WI (US)

(72) Inventor: Jack Klopfenstein, Brodhead, WI (US)

(21) Appl. No.: 18/123,947

(22) Filed: Mar. 20, 2023

(51) Int. Cl. B62M 3/02; A63B 22/06; B62M 1/36

(52) U.S. Cl. CPC B62M 3/02; A63B 22/0605; B62M 1/36; A63B 2022/0617; A63B 2022/0623

(57) ABSTRACT

A pedal cycle apparatus is disclosed in which a foot of a medically incapacitated user thereof engages a pedal for moving the pedal orbitally about a rotational axis of a crank hub. The apparatus includes a crank arm having a proximal and a distal end, the proximal end of the crank arm being rotatable about the rotational axis of the crank hub. A fastener fastens the pedal relative to the crank arm at a selectively variable radial distance from the rotational axis of the crank hub. The arrangement is such that in use of the pedal cycle apparatus, the foot of the medically incapacitated user engages the pedal so that the pedal moves orbitally about the rotational axis of a crank hub. The pedal rotates about an axis of rotation which is disposed parallel to the rotational axis of the crank hub such that selection by the user of an optimum radial distance of the pedal from the rotational axis of the crank hub is permitted.

### BACKGROUND OF THE INVENTION

### Field of the Invention

The present invention relates to a pedal cycle apparatus.

More specifically, the present invention relates to a pedal cycle apparatus in which the pedal is selectively movable relative to a crank arm.

### Background Information

After knee surgery, it is advantageous for the patient to exercise in order to facilitate healing and strengthening of the various muscles surrounding the treated knee. However, it is not uncommon for a patient to experience pain when attempting to pedal a normal exercise machine where both pedals are equally spaced radially on opposite sides of a crank hub. Often, the patient will experience difficulty bending the treated knee to the same extent as the non-treated knee. In order to overcome this problem, the present invention provides an arrangement in which for the treated knee, the pedal is moved much closer radially to the crank hub. Accordingly, during pedaling, the treated knee bends far less than the non-treated knee.

Also, according to the present invention, as the healing process continues and the treated knee becomes stronger, the pedal can be refastened to the crank arm at a slightly greater radial distance from the crank hub. When the treated knee has fully recovered, the pedal can then be fastened to the crank arm at the same radial distance from the crank hub as the radial distance of the pedal disposed on the non-treated knee side so that the pedals are disposed diametrically opposite to each other as in a conventional cycle machine.

Furthermore, the concept of the present invention is also applicable to a conventional bicycle. In such a bicycle according to the present invention, the pedal to be engaged by the user's foot on the treated knee side is fastened to the crank arm at an optimum radial distance from the bicycle crank hub so that any pain experienced by the user is minimized.

Accordingly, the present invention relates to a unique pedal cycle apparatus which enables the user thereof to exercise a treated knee by initially moving the pedal closer to the crank hub.

Therefore, a primary object of the present invention is the provision of a pedal cycle apparatus which enables a medically incapacitated patient with knee surgery to exercise.

Another objective of the present invention is the provision of a pedal cycle apparatus such as an exercise machine to be rapidly adjusted to fasten a pedal at a selected radial distance from a crank hub.

Yet another object of the present invention is the provision of a pedal cycle apparatus in which a bicycle can be converted to provide a pedal fastened at a selectively variable distance from a crank hub for use by a patient having knee replacement surgery or the like.

A further object of the present invention is the provision of a pedal cycle apparatus in which the pedal can be rapidly relocated at an optimal radial distance from a crank hub in order to minimize any pain experienced by a user during pedaling.

Other features and advantages of the present invention will be readily apparent to those skilled in the art by a consideration of the detailed description of a preferred embodiment of the present invention contained herein.

### SUMMARY OF THE INVENTION

The present invention relates to a pedal cycle apparatus in which a foot of a medically incapacitated user thereof engages a pedal for moving the pedal orbitally about a rotational axis of a crank hub. The apparatus includes a crank arm having a proximal and a distal end, the proximal end of the crank arm being rotatable about the rotational axis of the crank hub. A fastener fastens the pedal relative to the crank arm at a selectively variable radial distance from the rotational axis of the crank hub. The arrangement is such that in use of the pedal cycle apparatus, the foot of the medically incapacitated user engages the pedal so that the pedal moves orbitally, about the rotational axis of a crank hub. The pedal rotates about an axis of rotation which is disposed parallel to the rotational axis of the crank hub such that selection by the user of an optimum radial distance of the pedal from the rotational axis of the crank hub is permitted.

In a more specific embodiment of the present invention, the pedal cycle apparatus is a bicycle.

In an alternative embodiment of the present invention, the pedal cycle apparatus is a one-wheel exercise machine.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

Included in such modifications would be the application of the concept of this invention to an arrangement in which a crank arm defines a radially extending slot or groove cooperating with a fastener for securing a pedal at a selectively variable distance radially from a crank hub.

Also included in such modifications would be the provision of a portion of for example square, triangular or other cross-sectional configuration secured against relative rotation thereof by a correspondingly shaped aperture of the crank arm such that insertion of a fastening device through aligned holes defined by the crank arm and the portion is facilitated.

### BRIEF DESCRIPTION OF THE DRAWINGS

FIG. 1 is a side elevational view of a pedal cycle apparatus according to the present invention;

FIG. 2 is an enlarged view, partially in section of the pedal shown in FIG. 1

FIG. 3 is a side elevational view of a pedal cycle apparatus according to an alternative embodiment of the present invention in which the pedal cycle apparatus is a one-wheel exercise machine;

FIG. 4 is an enlarged view taken on the line 4-4 of FIG. 2

FIG. 5 is a similar view to that shown in FIG. 4 but shows another embodiment of the present invention;

FIG. 6 is a sectional view taken on the line 6-6 of FIG. 5;

FIG. 7 is a similar view to that shown in FIG. 2 but shows the pedal moved closer to the proximal end of the crank arm;

FIG. 8 is an enlarged view taken on the line 8-8 of FIG. 2;

FIG. 9 is a similar view to that shown in FIG. 8 but shows the fastening device in a second disposition thereof;

FIG. 10 is a similar view to that shown in FIGS. 8 and 9 but shows another embodiment of the present invention;

FIG. 11 is a similar view to that shown in FIG. 10 but shows the fastening device in a second disposition thereof;

FIG. 12 is an enlarged side elevational view partially in section of the fastening device shown in FIGS. 10 and 11;

FIG. 13 is a similar view to that shown in FIG. 12 but shows the fastening device disposed in the second disposition thereof;

FIG. 14 is a similar view to that shown in FIG. 10 but shows another embodiment of the present invention in which the fastener is of c-shaped configuration;

FIG. 15 is a side elevational view partially in section of a further embodiment of the present invention;

FIG. 16 is a similar view to that shown in FIG. 15 but shows another embodiment of the present invention;

FIG. 17 is a side elevational view of a further embodiment of the present invention;

FIG. 18 is a view taken on the line 18-18 shown in FIG. 17;

FIG. 19 is a similar view to that shown in FIG. 17 but shows the crank arm without the pedal anchor;

FIG. 20 is a view taken on the line 20-20 shown in FIG. 18;

FIG. 21 is a view taken on the line 21-21 shown in FIG. 20;

FIG. 22 is a view taken on the line 22-22 shown in FIG. 21; and

FIG. 23 is a sectional view taken on the line 23-23 shown in FIG. 17.

Similar reference characters refer to similar parts throughout the various views of the drawings.

Also, similar parts of the various embodiments of the present invention are indicated by the same reference characters but with a suffix added thereto.

### DETAILED DESCRIPTION OF THE DRAWINGS

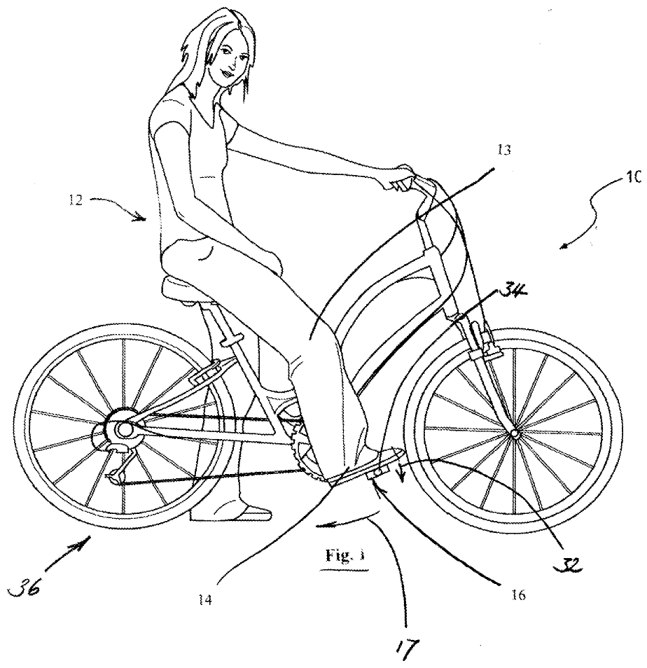

FIG. 1 is a side elevational view of a pedal cycle apparatus generally designated 10 according to the present invention. As shown in FIG. 1, the pedal cycle apparatus 10 is for use by a user generally designated 12 who is recovering from surgery to the knee 13. The foot 14 of the user 12 engages a pedal generally designated 16.

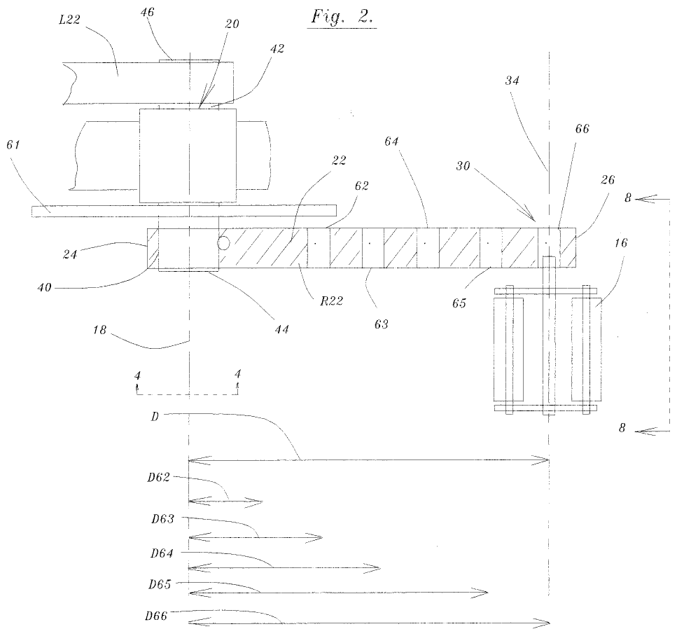

FIG. 2 is an enlarged view, partially in section of the pedal 16 shown in FIG. 1. As shown in FIGS. 1 and 2, the foot 14 of the user 12 moves the pedal 16 orbitally as indicated by the arrow 17 about a rotational axis 18 of a crank hub generally designated 20. The apparatus 10 includes a crank arm generally designated 22 having a proximal end 24 and a distal end 26. The proximal end 24 of the crank arm 22 is rotatable as indicated by the arrow 17 about the rotational axis 18 of the crank hub 20. A fastener generally designated 30 fastens the pedal 16 relative to the crank arm 22 at a selectively variable radial distance D from the rotational axis 18 of the crank hub 20. The arrangement is such that in use of the pedal cycle apparatus 10, the foot 14 of the user 12 engages the pedal 16 so that the pedal 16 moves orbitally about the rotational axis 18 of the crank hub 20 as indicated by arrow 17. Additionally, the pedal 16 rotates as indicated by the arrow 32 about an axis of rotation 34 which is disposed parallel to the rotational axis 18 of the crank hub 20 such that selection by the user 12 of an optimum radial distance D of the pedal 16 from the rotational axis 18 of the crank hub 20 is permitted.

In a more specific embodiment of the present invention, the pedal cycle apparatus 10 is a bicycle generally designated 36 as shown in FIG. 1.

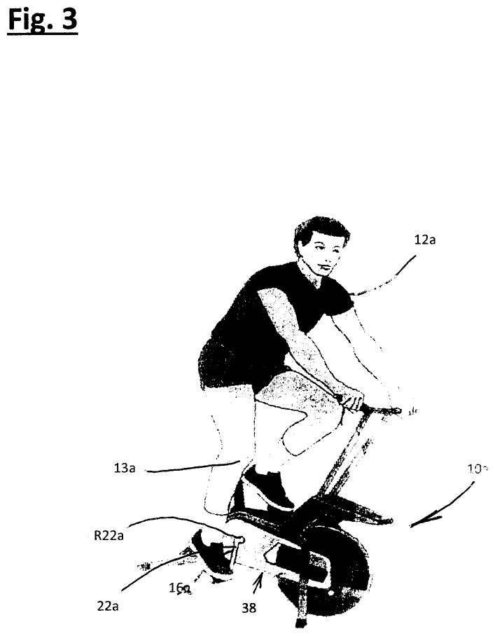

FIG. 3 is a side elevational view of a pedal cycle apparatus generally designated 10a according to an alternative embodiment of the present invention in which the pedal cycle apparatus 10a is a one-wheel exercise machine generally designated 38.

In both the bicycle and the one-wheel exercise machine embodiments shown in FIGS. 1 and 3 respectively, the crank arm 22 and 22a includes a right foot crank arm R22 and R22a and a left foot crank arm L22 and L22a (not shown) respectively.

As shown in FIG. 1, the proximal end 24 of the crank arm 22 defines a socket 40 and the apparatus 10 further includes an axle 42.

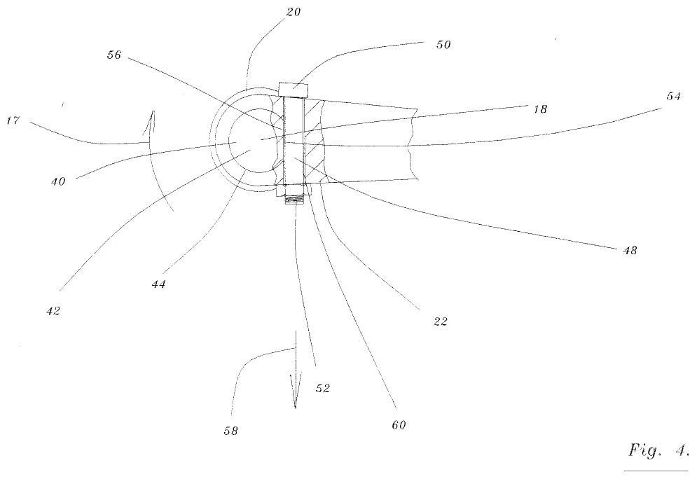

FIG. 4 is an enlarged view taken on the line 4-4 of FIG. 2. As shown in FIGS. 2 and 4, the axle 42 has a first and a second end 44 and 46 respectively. The axle 42 extends through the crank hub 20 such that the axle 42 is bearingly supported by the crank hub 20 for rotation about the rotational axis 18 of the crank hub 20 as indicated by the arrow 17 shown in FIG. 4.

Also, the socket 40 of the crank arm 22 receives therein the first end 44 of the axle 42.

Additionally, a cotter pin 48 has a first and a second extremity 50 and 52 respectively. The cotter pin 48 defines a wedge surface 54 which is disposed between the first and second extremity 50 and 52 of the cotter pin 48. The wedge surface 54 cooperates with a face 56 defined by the axle 42 such that when the cotter pin 48 is urged in a direction normal to the rotational axis 18 through a bore 60 defined by the crank arm 22 as indicated by the arrow 58, the cooperating wedge surface 54 and face 56 lock the crank arm 22 onto the axle 42.

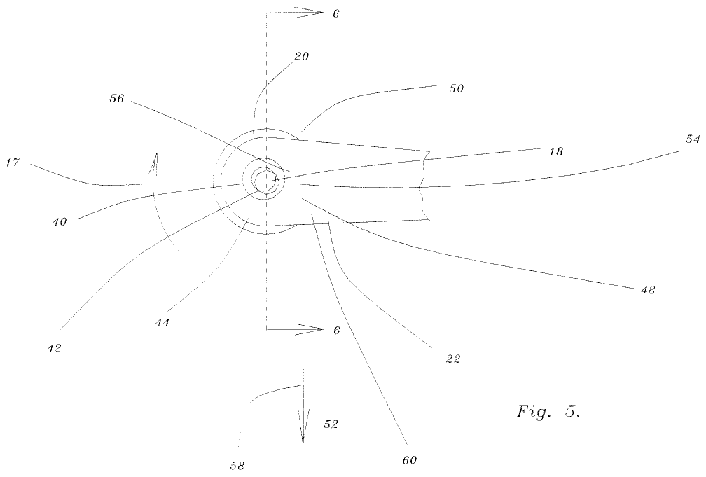

FIG. 5 is a similar view to that shown in FIG. 4 but shows another embodiment of the present invention. As shown in FIG. 5, the socket 40b of the crank arm 22b is tapered approximately one-half degree.

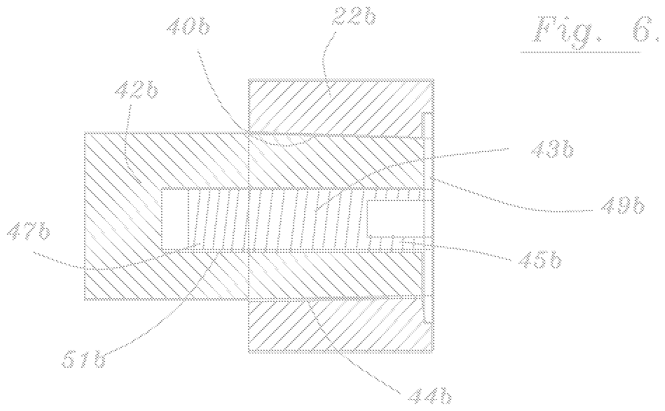

FIG. 6 is a sectional view taken on the line 6-6 of FIG. 5. As shown in FIG. 6, the tapered socket 40b cooperates with a correspondingly tapered end 44b of the axle 42b such that the tapered socket 40b receives therein the tapered end 44b of the axle 42b. The pedal cycle apparatus further includes a threaded fastener 43b having a first and a second end 45b and 47b respectively. The first end 45b of the fastener 43b defines a head 49b and the second end 47b of the fastener 43b threadably cooperates with an axially extending bore 51b defined by the tapered end 44b of the axle 42b. The arrangement is such that axial rotation of the head 49b relative to the axle 42b urges the socket 40b of the proximal end 24b of the crank arm 22b axially against the tapered end 44b of the axle 42b for locking the tapered end 44b of the axle 22b within the tapered socket 40b.

Those skilled in the art will appreciate that some exercise machines do not include an axle rotatably supported by a hub but rather have rods or the like hingedly secured to the crank arms with such rods rotating a wheel or similar device. All such arrangements are included within the arrangement according to the present invention.

As shown in FIG. 2, the crank arm 22 defines a plurality of apertures 62 to 66 disposed between the proximal and distal ends 24 and 26 of the crank arm 22. The apertures 62 to 66 are spaced radially from the rotational axis 18 and are spaced relative to each other such that each aperture is disposed at a different radial distance D62, D63, D64, D65 and D66 from the rotational axis 18.

As shown in FIG. 2, the fastener 30 removably fastens the pedal 16 relative to a selected aperture such as aperture 66 of the plurality of apertures 62 to 66. The arrangement is such that in use of the pedal cycle apparatus, when the pedal 16 is fastened by the fastener 30 relative to the selected aperture, the foot 14 of the medically incapacitated user 12 engages the pedal 16 so that the pedal 16 rotates about an axis of rotation 34 which is disposed parallel to the rotational axis 18 of the crank hub 20. This arrangement is such that selection by the user 12 of an optimum radial distance D of the pedal 16 from the rotational axis 18 of the crank hub 20 is permitted.

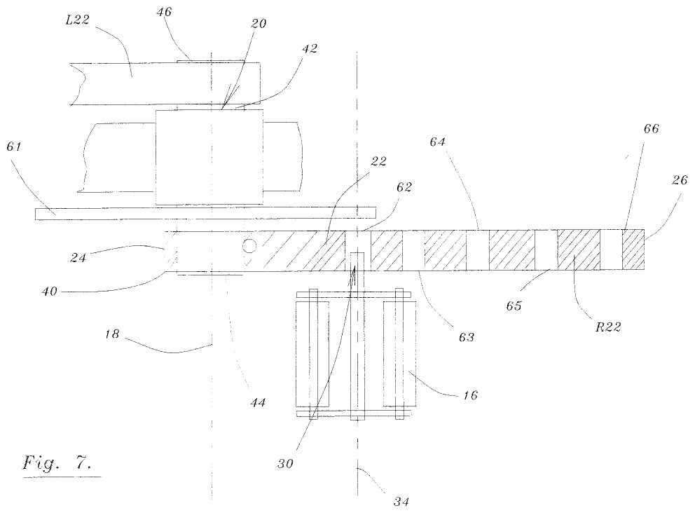

FIG. 7 is a similar view to that shown in FIG. 2 but shows the pedal 16 moved closer to the proximal end 24 of the crank arm 22. As shown in FIG. 7, the pedal 16 has been moved from aperture 66 as shown in FIG. 2 to aperture 62. The fastener 30 removably fastens the pedal 16 relative to the selected aperture 62 of the plurality of apertures 62 to 66. The arrangement is such that in use of the pedal cycle apparatus 10, when the pedal 16 is fastened by the fastener 30 relative to a selected aperture such as aperture 62, the foot 14 of the user 12 engages the pedal 16 so that the pedal 16 rotates about the axis of rotation 34 which is disposed parallel to the rotational axis 18 of the crank hub 20. By this arrangement selection by the user 12 of an optimum radial distance D of the pedal 16 from the rotational axis 18 of the crank hub 20 is permitted.

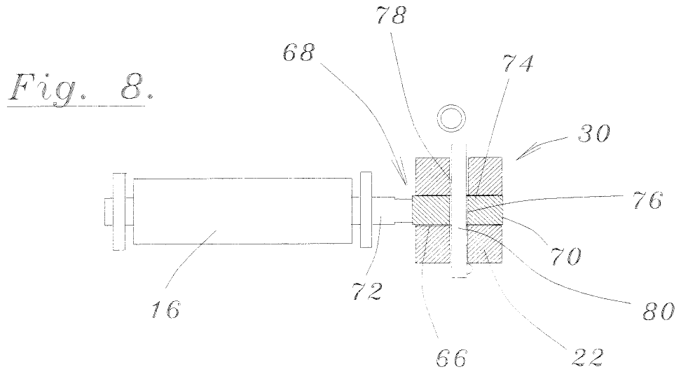

FIG. 8 is an enlarged view taken on the line 8-8 of FIG. 2. As shown in FIG. 8, the fastener 30 includes an anchor generally designated 68 having a first and a second termination 70 and 72 for anchoring the pedal 16 to the selected aperture such as aperture 66. The anchor 68 includes a portion 74 having a cylindrical-shaped external configuration. The portion 74 is disposed between the first and the second terminations 70 and 72 of the anchor 68. Moreover, the portion 74 defines a hole 76 that extends diametrically through the portion 74. Each of the apertures such as aperture 66 defines a further hole 78 extending through the crank arm 22 in a direction which is aligned with the hole 76 defined by the portion 74 such that when the cylindrical-shaped portion 74 is inserted within a selected aperture 66, the hole 76 of the portion 74 is aligned with the further hole 78.

Additionally, a removable fastening device 80 removably extends through the further hole 78 of the crank arm 22 and the hole 76 defined by the portion 74. The arrangement is such that in a first disposition of the removable fastening device 80 as shown in FIG. 8, the removable fastening device 80 extends through the hole 76 and the further hole 78 for locking the pedal 16 onto the crank arm 22 at the selected distance D66 from the crank hub 20.

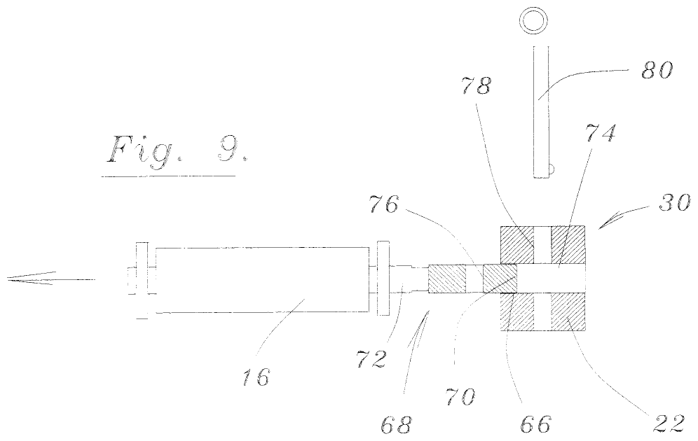

FIG. 9 is a similar view to that shown in FIG. 8 but shows the fastening device 80 in a second disposition thereof. As shown in FIG. 9, when the removable fastening device 80 is disposed in a second disposition thereof, with the removable fastening device 80 removed from the hole 76 and further hole 78, the pedal 16 is unlocked from the crank arm 22 so that the pedal 16 can be moved to another aperture of the plurality of apertures 62 to 66.

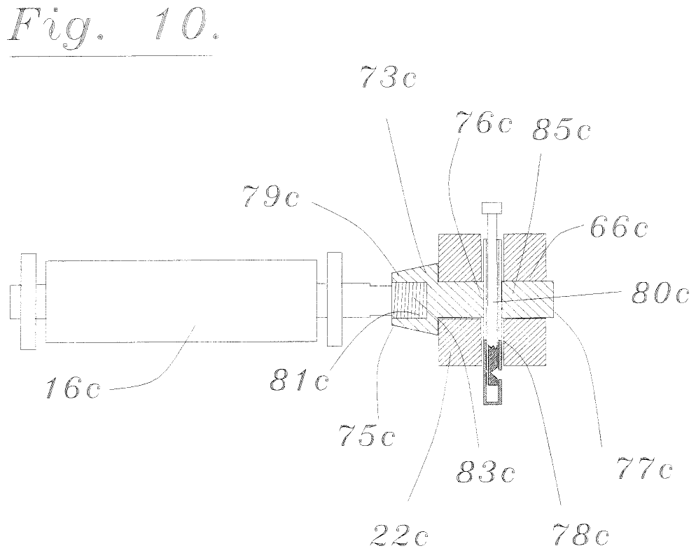

FIG. 10 is a similar view to that shown in FIGS. 8 and 9 but shows another embodiment of the present invention. As shown in FIG. 10, an adapter 73c has a first and a second extremity 75c and 77c. The adapter 73c includes a first part 79c disposed adjacent to the first extremity 75c of the adapter 73c. The first part 79c defines a threaded cavity 81c for threadably receiving therein an externally threaded standard stud 83c of the pedal 16c.

A second part 85c of the adapter 73c is of cylindrical configuration and is disposed adjacent to the second extremity 77c of the adapter 73c. The second part 85c is removably received within the selected aperture such as aperture 66c of the plurality of apertures 62 to 66. The second part 85c defines a hole 76c that extends diametrically through the second part 85c of the adapter 73c.

Each of the apertures such as aperture 66c defines a further hole 78c extending through the crank arm 22c in a direction which is aligned with the hole 76c defined by the second part 85c. The arrangement is such that when the second part 85c of the adapter 73c is inserted within the selected aperture 66c, the hole 76c of the second part 85c is aligned with the further hole 78c. A removable fastening device 80c removably extends through the further hole 78c of the crank arm 22c and the hole 76c defined by the second part 85c. The arrangement is such that in a first disposition of the removable fastening device 80c as shown in FIG. 10, the removable fastening device 80c extends through the hole 76c and further hole 78c for locking the pedal 16c onto the crank arm 22c at the selected distance such as D66 from the crank hub 20.

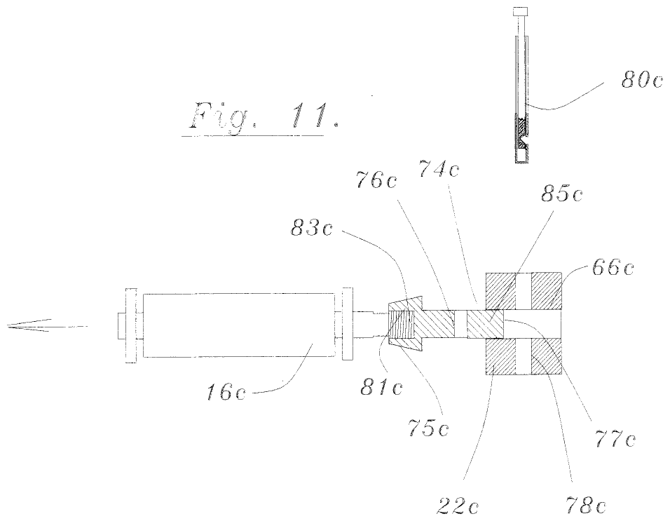

FIG. 11 is a similar view to that shown in FIG. 10 but shows the fastening device 80c in a second disposition thereof. As shown in FIG. 11, when the removable fastening device 80c is disposed in a second disposition thereof, with the removable fastening device 80c removed from the hole 76c and further hole 78c, the pedal 16c is unlocked from the crank arm 22c so that the pedal 16c can be moved to another aperture of the plurality of apertures 62 to 66.

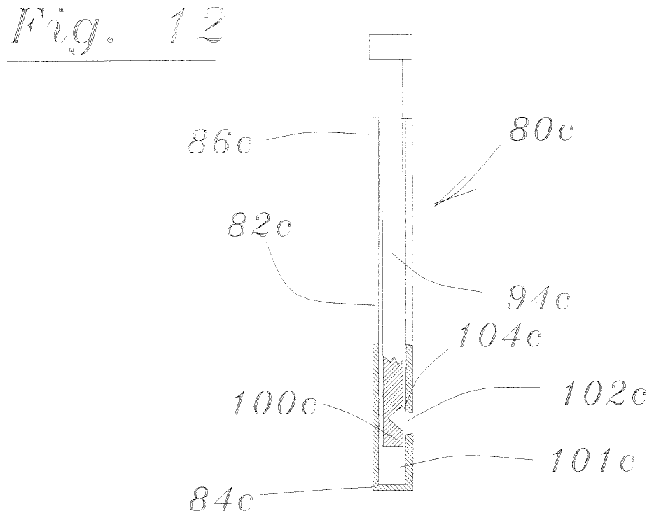

FIG. 12 is an enlarged side elevational view partially in section of the fastening device 80c shown in FIGS. 10 and 11. As shown in FIG. 12, the fastening device 80c includes an elongate body 82c having a first and a second end 84c and 86c. The first end 84c of the elongate body 82c extends through the aligned further hole 78c defined by the crank arm 22c and the hole 76c of the second part 85c as shown in FIG. 10. The arrangement is such that when the elongate body 82c is in a first disposition thereof as shown in FIG. 10, with the elongate body 82c extending through the further hole 78c defined by the crank arm 22c and the hole 76c of the second part 85c, the pedal 16c is anchored relative to a selected aperture such as aperture 66c.

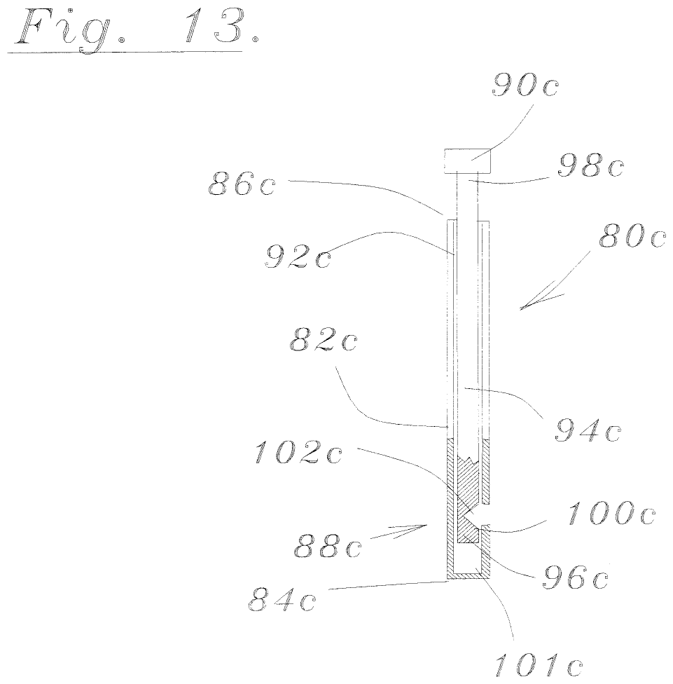

FIG. 13 is a similar view to that shown in FIG. 12 but shows the fastening device 80c disposed in the second disposition thereof. As shown in FIG. 13, when the elongate body 82c is in the second disposition thereof removed from the further hole 78c extending through the crank arm 22c and the hole 76c extending through the second part 85c, the pedal 16c is released from the selected aperture 66c so that the pedal 16c can be moved for attachment thereof to another aperture of the plurality of apertures. More specifically, the elongate body 82c includes a retainer generally designated 88c disposed adjacent to the first end 84c of the elongate body 82c for retaining the elongate body 82c within the holes 76c and 78c when the elongate body 82c is in the first disposition thereof.

Also, an extractor or button 90c is disposed adjacent to the second end 86c of the elongate body 82c for extracting the elongate body 82c from the holes 76c and 78c when the elongate body 82c is in the second disposition thereof.

Additionally, the elongate body 82c defines an axial bore 92c which extends between the first and second ends 84c and 86c of the elongate body 82c.

The retainer 88c includes a rod 94c slidably disposed within the axial bore 92c of the elongate body 82c, the rod 94c having a first and a second end 96c and 98c. The first end 96c of the rod 94c defining a cam 100c.

Moreover, a ball 102c is disposed adjacent to the cam 100c such that when as shown in FIG. 12, the rod 94c is urged by a spring 101c towards the second end 86c of the elongate body 82c, the cam 100c urges the ball 102c radially outwardly through a slot 104c defined by the first end 84c of the elongate body 82c. The arrangement is such that the elongate body 82c is locked against removal thereof from the holes 76c and 78c when the elongate body 82c is in the first disposition thereof.

As shown in FIG. 13, the extractor 90c is secured to the second end 98c of the rod 94c such that when the extractor 90c is moved towards the first end 84c of the elongate body 82c, the rod 94c is moved against the biasing device or spring 101c towards the first end 84c of the elongate body 82c to the second disposition thereof. Accordingly, the cam 100c permits the ball 102c to move radially inwards within the elongate body 82c to facilitate removal of the elongate body 82c from the holes 76c and 78c for removing the pedal 16c.

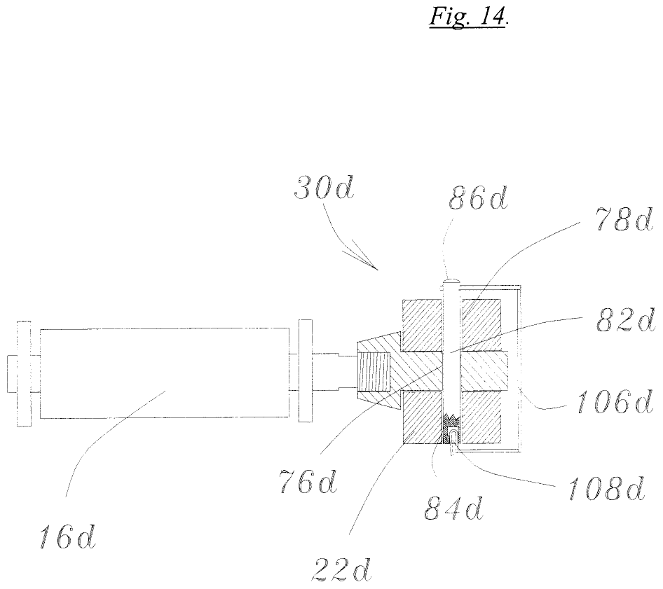

FIG. 14 is a similar view to that shown in FIG. 10 but shows another embodiment of the present invention. As shown in FIG. 14, the fastener is of c-shaped configuration. The fastener 30d includes an elongate body 82d having a first and a second end 84d and 86d. A relatively flexible c-shaped band 106d is secured to the second end 86d of the elongate body 82d. However, the opposite end 108d of the band 106d cooperates with the first end 84d of the elongate body 82d when in the locked first disposition of the elongate body 82d. In such first disposition, the elongate body 82d extends through the holes 76d and 78d for locking the pedal 16d to the crank arm 22d. In the second disposition, the end 108d is released from the end 84d and the elongated body 82d is removed from the holes 76d and 78d to unlock the pedal 16d.

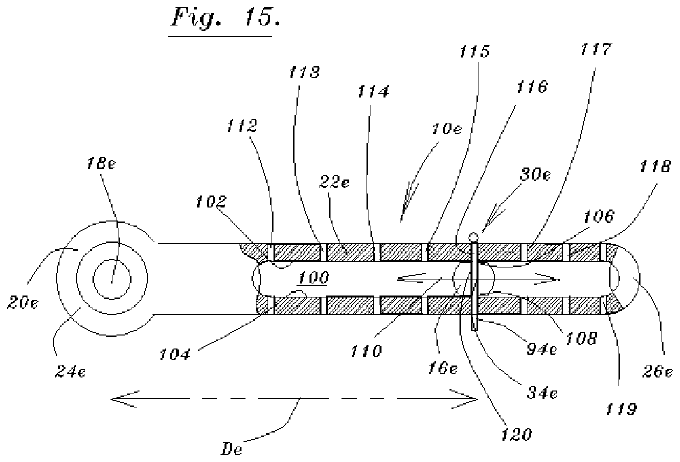

FIG. 15 is a side elevational view partially in section of a further embodiment of the present invention. As shown in FIG. 15, the crank arm 22e defines a slot 100 which extends between the proximal end 24e and the distal end 26e of the crank arm 22e. The fastener 30e cooperates with the slot 100 for fastening the pedal 16e relative to the crank arm 22e at a selectively variable radial distance De from the rotational axis 18e of the crank hub 20e such that in use of the pedal cycle apparatus 10e, the foot of the medically incapacitated user engages the pedal 16e so that the pedal 16e moves orbitally about the rotational axis 18e of the crank hub 20e, the pedal 16e rotating about an axis of rotation 34e which is disposed parallel to the rotational axis 18e of the crank hub 20e such that selection by the user of an optimum radial distance of the pedal 16e from the rotational axis 18e of the crank hub 20e is permitted.

More specifically, the slot 100 has a first wall 102 and a second wall 104 disposed spaced and parallel to the first wall 102. The fastener 30e defines a first edge 106 and a second edge 108 disposed spaced and parallel to the first edge 106 such that in an unfastened disposition of the fastener 30e, the first and the second edges 106 and 108 respectively of the fastener 30e cooperate with the first and the second walls 102 and 104 respectively of the slot 100 for permitting slidable movement of the pedal 16e along the slot 100 as indicated by the arrow 110 for adjusting the optimum radial distance of the pedal 16e.

The crank arm 22e defines a plurality of holes 112, 113, 114, 115, 116, 117, 118 and 119 disposed spaced relative to each other between the proximal and distal ends 24e and 26e of the crank arm 22e, each of the plurality of holes 112 to 119 being selectively aligned with a corresponding drilling 120 defined by the fastener 30e. A locking pin 94e extends through the selectively aligned hole 116 and drilling 120 for locking the fastener 30e to the crank arm 22e such that in a fastened disposition of the fastener 30e as shown in FIG. 15, the first and the second edges 106 and 108 of the fastener 30e cooperate with the first and the second walls 102 and 104 of the slot 100 for preventing movement of the pedal 16e along the slot 100 thereby locking the optimum radial distance of the pedal 16e.

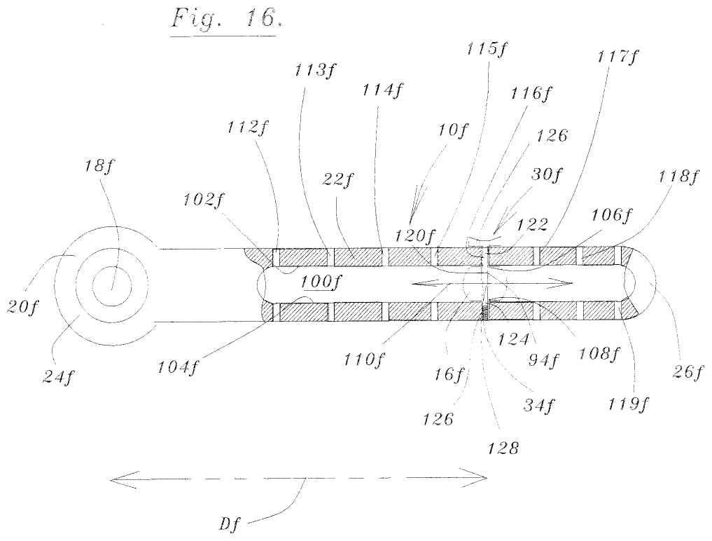

FIG. 16 is a similar view to that shown in FIG. 15 but shows a further embodiment of the present invention. As shown in FIG. 16, a pedal cycle apparatus 10f includes a locking pin 94f having a first end 122 and a second end 124. A winged head 126 is rigidly secured to the first end 122 of the locking pin 94f. The second end 124 of the locking pin 94f defines an external thread 126. Additionally, the selectively aligned hole 116f defines an internal thread 128 which threadably cooperates with the external thread 126 of the locking pin 94f. The arrangement is such that when the fastener 30f is in the fastened disposition as shown in FIG. 16, the first and the second edges 106f and 108f of the fastener 30f cooperate with the first and the second walls 102f and 104f respectively of the slot 100f for preventing movement of the pedal 16f along the slot 100f thereby locking the optimum radial distance of the pedal Df.

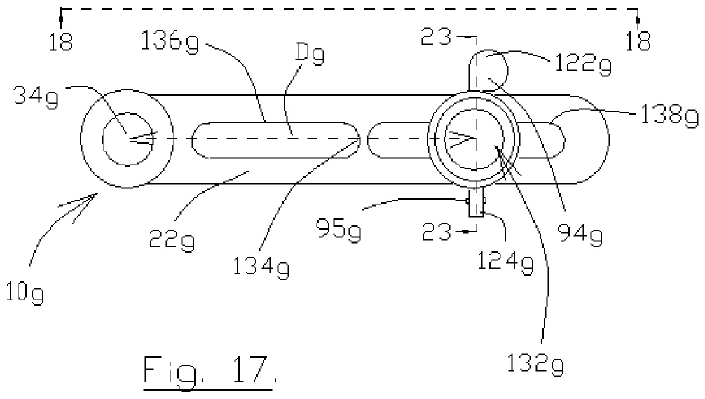

FIG. 17 is a side elevational view of a further embodiment of the present invention. As shown in FIG. 17, a pedal cycle apparatus generally designated 10g includes a locking pin 94g having a first end 122g and a second end 124g. The second end 124g of the locking pin 94g includes a spring-loaded ball 95g for retaining the pin 94g within a pedal anchor generally designated 132g.

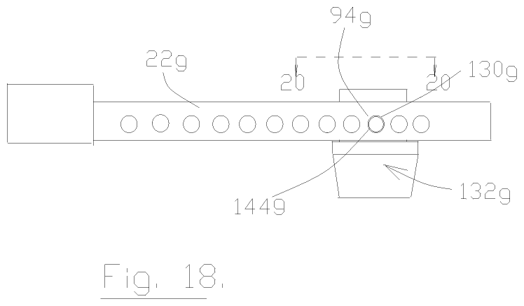

FIG. 18 is a view taken on the line 18-18 shown in FIG. 17. As shown in FIG. 18, the spring-loaded ball 95g shown in FIG. 17, retains the inserted pin 94g within a hole 130g of the pedal anchor 132g.

As shown in FIG. 17, a crank arm 22g defines two slots 136g and 138g with a reinforcing web 134g separating the slots 136g and 138g.

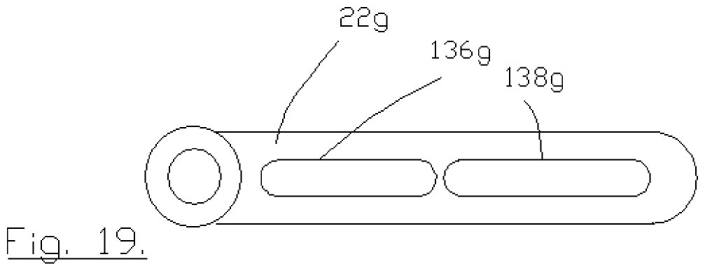

FIG. 19 is a similar view to that shown in FIG. 17 but shows the crank arm 22g without the pedal anchor 132g.

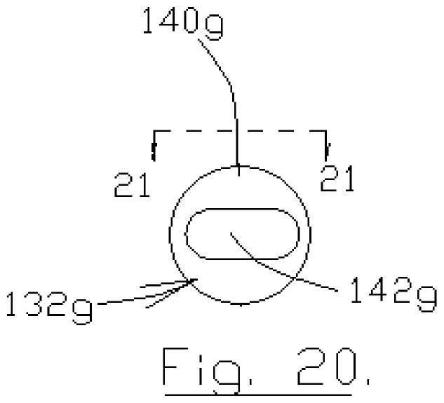

FIG. 20 is a view taken on the line 20-20 shown in FIG. 18. As shown in FIG. 20, the pedal anchor generally designated 132g includes a head 140g and a stud 142g extending from the head 140g. The stud 142g is of flattened configuration so that the stud 142g is able to be selectively located in and to cooperate with either of the slots 136g or 138g.

As shown in FIG. 17, the flattened configuration of the stud 142g prevents rotation of the stud 142g within the slots 136g or 138g. Once the stud 142g is located at the required distance from the axis of rotation 34g of the crank arm 22g, as indicated by way of example by the arrow Dg, the locking pin 94g is inserted as shown in FIG. 18 through a corresponding hole such as hole 144g defined by the crank arm 22g.

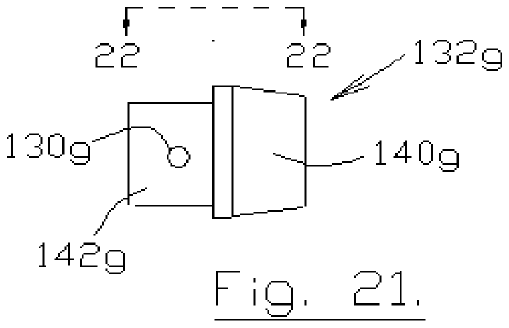

FIG. 21 is a view taken on the line 21-21 shown in FIG. 20. As shown in FIG. 21, the pin 94g, as shown in FIG. 17, is then guided through the hole 130g defined by the stud 142g.

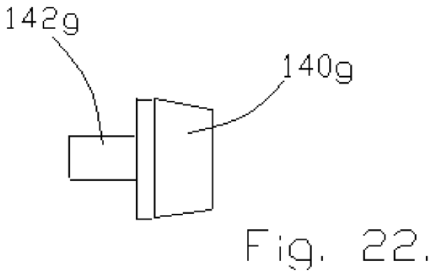

FIG. 22 is a view taken on the line 22-22 shown in FIG. 21. As shown in FIG. 22, the stud 142g is flattened in order for it to be retained within either the slot 136g or 138g as shown in FIG. 19.

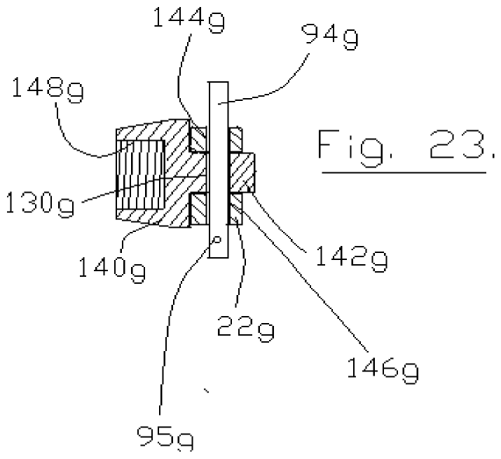

FIG. 23 is a sectional view taken on the line 23-23 shown in FIG. 17. As shown in FIG. 23, the pin 94g extends through the hole 144g of the crank arm 22g and then through the hole 130g defined by the stud 142g and then through a further hole 146g defined by the crank arm 22g. The head 140g defines a threaded blind hole 148g for the threadable reception therein of the pedal (not shown).

In operation of the pedal cycle apparatus 10 according to the present invention, the foot 14 of the user 12 engages the pedal 16 for moving the pedal 16 orbitally about the rotational axis 18 of a crank hub 20. The pedal 16 is fastened to the crank arm 22 at a selectively variable radial distance D from the rotational axis 18 of the crank hub 20 such that in use of the pedal cycle apparatus 10, the foot 14 of the user 12 engages the pedal 16 so that the pedal 16 moves orbitally about the rotational axis 18 of a crank hub 20. Additionally, the pedal 16 rotates about the axis of rotation 34 which is disposed parallel to the rotational axis 18 of the crank hub 20 such that selection by the user 12 of an optimum radial distance D of the pedal 16 from the rotational axis 18 of the crank hub 20 is permitted.

The present invention provides a unique arrangement for converting a bicycle or exercise machine so that a pedal thereof can be selectively fastened at an optimal distance from a crank hub for engagement by the foot of a user recovering from knee surgery.

What is claimed is:

1. A pedal cycle apparatus in which a foot of a medically incapacitated user thereof engages a pedal for moving the pedal orbitally about a rotational axis of a crank hub, said apparatus comprising:
a crank arm having a proximal and a distal end, said proximal end of said crank arm being rotatable about the rotational axis of the crank hub; and
a fastener for fastening the pedal relative to said crank arm at a selectively variable radial distance from the rotational axis of the crank hub such that in use of the pedal cycle apparatus, the foot of the medically incapacitated user engages the pedal so that the pedal moves orbitally about the rotational axis of the crank hub, the pedal rotating about an axis of rotation which is disposed parallel to said rotational axis of the crank hub such that selection by the user of an optimum radial distance of the pedal from the rotational axis of the crank hub is permitted.

2. A pedal cycle apparatus as set forth in claim 1 wherein the pedal cycle apparatus is a bicycle.

3. A pedal cycle apparatus as set forth in claim 1 wherein the pedal cycle apparatus is a one-wheel exercise machine.

4. A pedal cycle apparatus as set forth in claim 1 wherein said crank arm is a right foot crank arm.

5. A pedal cycle apparatus as set forth in claim 1 wherein said crank arm is a left foot crank arm.

6. A pedal cycle apparatus as set forth in claim 1 wherein
said proximal end of said crank arm defines a socket;
said apparatus further including:
an axle having a first and a second end, said axle extending through the crank hub such that said axle is bearingly supported by the crank hub for rotation about said rotational axis of the crank hub;
said socket of said crank arm receiving therein one of said ends of said axle.

7. A pedal cycle apparatus as set forth in claim 6 further including:
a cotter pin having a first and a second extremity, said cotter pin defining a wedge surface disposed between said first and a second extremity, said wedge surface cooperating with a face defined by said axle such that when said cotter pin is urged in a direction normal to said rotational axis through a bore defined by said crank arm, said cooperating wedge surface and face lock said crank arm onto said axle.

8. A pedal cycle apparatus as set forth in claim 6 wherein
said socket of said crank arm is tapered and cooperates with a correspondingly tapered end of said axle such that said tapered socket receives therein said tapered end of said axle;
said pedal cycle apparatus further including:
a threaded fastener having a first and a second end, said first end of said fastener defining a head, said second end of said fastener threadably cooperates with an axially extending bore defined by said tapered end of said axle such that axial rotation of said head relative to said axle urges said socket of said proximal end of said crank arm axially against said tapered end of said axle for locking said tapered end of said axle within said tapered socket.

9. A pedal cycle apparatus as set forth in claim 1 wherein
said crank arm defines a plurality of apertures disposed between said proximal and distal ends of said crank arm, said apertures being spaced radially from the rotational axis and spaced relative to each other such that each aperture is disposed at a different radial distance from said rotational axis;
said fastener removably fastening the pedal relative to a selected aperture of said plurality of apertures such that in use of the pedal cycle apparatus, when the pedal is fastened by said fastener relative to said selected aperture, the foot of the medically incapacitated user engages the pedal so that the pedal rotates about an axis of rotation which is disposed parallel to said rotational axis of the crank hub such that selection by the user of an optimum radial distance of the pedal from the rotational axis of the crank hub is permitted.

10. A pedal cycle apparatus as set forth in claim 9 wherein said fastener includes:
an anchor having a first and a second termination for anchoring the pedal to said selected aperture;
said anchor including:
a portion having a cylindrical-shaped external configuration; said portion being disposed between said first and said second termination of said anchor, said portion defining a hole that extends diametrically through said portion;
each of said apertures defining a further hole extending through said crank arm in a direction which is aligned with said hole defined by said portion such that when said cylindrical-shaped portion is inserted within a selected aperture, said hole of said portion is aligned with said further hole;
a removable fastening device removably extending through said further hole of said crank arm and said hole defined by said portion such that in a first disposition of said removable fastening device, said removable fastening device extends through said hole and further hole for locking the pedal onto the crank arm at said selected distance from said crank hub and when said removable fastening device is disposed in a second disposition thereof, with said removable fastening device removed from said hole and further hole, said pedal is unlocked from said crank arm so that said pedal can be moved to another aperture of said plurality of apertures.

11. A pedal cycle apparatus as set forth in claim 10 wherein said fastener includes:
an adapter having a first and a second extremity, said adapter including:
a first part disposed adjacent to said first extremity of said adapter, said first part defining a threaded cavity for threadably receiving therein an externally threaded standard stud of the pedal;
a second part of cylindrical configuration disposed adjacent to said second extremity of said adapter, said second part being removably received within said selected aperture of said plurality of apertures, said second part defining a hole that extends diametrically through said second part;
each of said apertures defining a further hole extending through said crank arm in a direction which is aligned with said hole defined by said second part such that when said second part of said adapter is inserted within said selected aperture, said hole of said second part is aligned with said further hole;
a removable fastening device removably extending through said further hole of said crank arm and said hole defined by said second part such that in a first disposition of said removable fastening device, said removable fastening device extends through said hole and further hole for locking the pedal onto the crank arm at said selected distance from said crank hub and when said removable fastening device is disposed in a second disposition thereof, with said removable fastening device removed from said hole and further hole, said pedal is unlocked from said crank arm so that said pedal can be moved to another aperture of said plurality of apertures.

12. A pedal cycle apparatus as set forth in claim 10 wherein said fastener includes:
an elongate body having a first and a second end, said first end of said elongate body extending through aligned holes defined by said crank arm and said anchor such that when said elongate body is in a first disposition thereof with said elongate body extending through said holes defined by said crank arm and said anchor, the pedal is anchored relative to a selected aperture and when said elongate body is in a second disposition thereof removed from said holes extending through said crank arm and said anchor, the pedal is released from said selected aperture so that the pedal can be moved for attachment thereof to another aperture of said plurality of apertures.

13. A pedal cycle apparatus as set forth in claim 12 wherein said elongate body includes:
a retainer disposed adjacent to said first end of said elongate body for retaining said elongate body within said holes when said elongate body is in said first disposition thereof;
an extractor disposed adjacent to said second end of said elongate body for extracting said elongate body from said holes when said elongate body is in said second disposition thereof.

14. A pedal cycle apparatus as set forth in claim 13 wherein said elongate body defines an axial bore extending between said first and second ends of said elongate body;
said retainer including:
a rod slidably disposed within said axial bore of said elongate body, said rod having a first and a second end, said first end of said rod defining a cam;
a ball disposed adjacent to said cam such that when said rod is urged towards said second end of said elongate body, said cam urges said ball radially outwardly through a slot defined by said first end of said elongate body such that said elongate body is locked against removal thereof from said holes when said elongate body is in said first disposition thereof
a biasing device for urging said rod towards said second end of said elongate body;
said extractor being secured to said second end of said rod such that when said extractor is moved towards said first end of said elongate body, said rod is moved against said biasing device towards said first end of said elongate body so that said cam permits said ball to move radially inwards to facilitate removal of said elongate body from said holes.

15. A pedal cycle apparatus as set forth in claim 1 wherein
said crank arm defines a slot which extends between said proximal and said distal end of said crank arm;
said fastener cooperating with said slot for fastening the pedal relative to said crank arm at a selectively variable radial distance from the rotational axis of the crank hub such that in use of the pedal cycle apparatus, the foot of the medically incapacitated user engages the pedal so that the pedal moves orbitally about the rotational axis of the crank hub, the pedal rotating about an axis of rotation which is disposed parallel to said rotational axis of the crank hub such that selection by the user of an optimum radial distance of the pedal from the rotational axis of the crank hub is permitted.

16. A pedal cycle apparatus as set forth in claim 15 wherein
said slot has a first wall and a second wall disposed spaced and parallel to said first wall;
said fastener defining a first edge and a second edge disposed spaced and parallel to said first edge such that in an unfastened disposition of said fastener, said first and said second edges of said fastener cooperate with said first and said second walls of said slot for permitting slidable movement of the pedal along said slot for adjusting said optimum radial distance of the pedal;
said crank arm defining a plurality of holes disposed spaced relative to each other between said proximal and distal ends of said crank arm, each of said plurality of holes being selectively aligned with a corresponding drilling defined by said fastener;
a locking pin extending through said selectively aligned hole and drilling for locking said fastener to said crank arm such that in a fastened disposition of said fastener, said first and said second edges of said fastener cooperate with said first and said second walls of said slot for preventing movement of the pedal along said slot thereby locking said optimum radial distance of the pedal.

17. A pedal cycle apparatus as set forth in claim 16 wherein
said locking pin has a first and a second end;
a winged head rigidly secured to said first end of said locking pin;
said second end of said locking pin defining an external thread;
said selectively aligned hole defining an internal thread which threadably cooperates with said external thread of said locking pin when said fastener is in said fastened disposition, said first and said second edges of said fastener cooperate with said first and said second walls of said slot for preventing movement of the pedal along said slot thereby locking said optimum radial distance of the pedal.

18. A pedal cycle apparatus in which a foot of a medically incapacitated user thereof engages a pedal for moving the pedal orbitally about a rotational axis of a crank hub, said apparatus comprising:
a crank arm having a proximal and a distal end, said proximal end of said crank arm being rotatable about the rotational axis of the crank hub;
a fastener for fastening the pedal relative to said crank arm at a selectively variable radial distance from the rotational axis of the crank hub such that in use of the pedal cycle apparatus, the foot of the medically incapacitated user engages the pedal so that the pedal moves orbitally about the rotational axis of a crank hub, the pedal rotating about an axis of rotation which is disposed parallel to said rotational axis of the crank hub such that selection by the user of an optimum radial distance of the pedal from the rotational axis of the crank hub is permitted;
said crank arm defining a plurality of apertures disposed between said proximal and distal ends of said crank arm, said apertures being spaced radially from the rotational axis and spaced relative to each other such that each aperture is disposed at a different radial distance from said rotational axis;
said fastener removably fastening the pedal relative to a selected aperture of said plurality of apertures;
said fastener including:
a portion removably disposed within said selected aperture of said plurality of apertures, said portion being disposed between the pedal and said selected aperture, said portion having an external configuration which cooperates with a corresponding internal shape of said selected aperture such that in a first disposition of said portion, said portion is disposed within said selected aperture such that said external configuration of said portion and said corresponding internal shape of said selected aperture interact for preventing relative rotation therebetween, said portion defining a hole which in said first disposition of said portion is aligned with a further hole defined by said crank arm;
a removable fastening device removably extending through said aligned further hole of said crank arm and said hole defined by said portion such that in said first disposition, said removable fastening device extends through said hole and further hole for locking said portion and the pedal secured thereto onto the crank arm at said optimum radial distance from said crank hub and when said portion is disposed in a second disposition thereof with said removable fastening device removed from said hole and further hole, said portion is unlocked from said crank arm so that the pedal can be moved to another aperture of said plurality of apertures.

19. A pedal cycle apparatus in which a foot of a medically incapacitated user thereof engages a pedal for moving the pedal orbitally about a rotational axis of a crank hub, said apparatus comprising:
a crank arm having a proximal and a distal end, said proximal end of said crank arm being rotatable about the rotational axis of the crank hub;
a fastener for fastening the pedal relative to said crank arm at a selectively variable radial distance from the rotational axis of the crank hub such that in use of the pedal cycle apparatus, the foot of the medically incapacitated user engages the pedal so that the pedal moves orbitally about the rotational axis of a crank hub, the pedal rotating about an axis of rotation which is disposed parallel to said rotational axis of the crank hub such that selection by the user of an optimum radial distance of the pedal from the rotational axis of the crank hub is permitted;
said proximal end of said crank arm defining a socket;
said apparatus further including:
an axle having a first and a second end, said axle extending through the crank hub such that said axle is bearingly supported by the crank hub for rotation about said rotational axis of the crank hub;
said socket of said crank arm receiving therein one of said ends of said axle;
said socket of said crank arm being tapered and cooperating with a correspondingly tapered end of said axle such that said tapered socket receives therein said tapered end of said axle;
said pedal cycle apparatus further including:
a threaded fastener having a first and a second end, said first end of said fastener defining a head, said second end of said fastener threadably cooperates with an axially extending bore defined by said tapered end of said axle such that axial rotation of said head relative to said axle urges said socket of said proximal end of said crank arm axially against said tapered end of said axle for locking said tapered end of said axle within said tapered socket;
said crank arm defining a plurality of apertures disposed between said proximal and distal ends of said crank arm, said apertures being spaced radially from the rotational axis and spaced relative to each other such that each aperture is disposed at a different radial distance from said rotational axis;
said fastener removably fastening the pedal relative to a selected aperture of said plurality of apertures such that in use of the pedal cycle apparatus, when the pedal is fastened by said fastener relative to said selected aperture, the foot of the medically incapacitated user engages the pedal so that the pedal rotates about an axis of rotation which is disposed parallel to said rotational axis of the crank hub such that selection by the user of an optimum radial distance of the pedal from the rotational axis of the crank hub is permitted;
said fastener including:
an anchor having a first and a second termination for anchoring the pedal to said selected aperture;
said anchor including:
a portion having a cylindrical-shaped external configuration; said portion being disposed between said first and said second termination of said anchor, said portion defining a hole that extends diametrically through said portion;
each of said apertures defining a further hole extending through said crank arm in a direction which is aligned with said hole defined by said portion such that when said cylindrical-shaped portion is inserted within a selected aperture, said hole of said portion is aligned with said further hole;
a removable fastening device removably extending through said further hole of said crank arm and said hole defined by said portion such that in a first disposition of said removable fastening device, said removable fastening device extends through said hole and further hole for locking the pedal onto the crank arm at said selected distance from said crank hub and when said removable fastening device is disposed in a second disposition thereof, with said removable fastening device removed from said hole and further hole, said pedal is unlocked from said crank arm so that said pedal can be moved to another aperture of said plurality of apertures;
said fastener further including:
an elongate body having a first and a second end, said first end of said elongate body extending through aligned holes defined by said crank arm and said anchor such that when said elongate body is in a first disposition thereof with said elongate body extending through said holes defined by said crank arm and said anchor, the pedal is anchored relative to a selected aperture and when said elongate body is in a second disposition thereof removed from said holes extending through said crank arm and said anchor, the pedal is released from said selected aperture so that the pedal can be moved for attachment thereof to another aperture of said plurality of apertures;
said elongate body including:
a retainer disposed adjacent to said first end of said elongate body for retaining said elongate body within said holes when said elongate body is in said first disposition thereof;
an extractor disposed adjacent to said second end of said elongate body for extracting said elongate body from said holes when said elongate body is in said second disposition thereof;
said elongate body defining an axial bore extending between said first and second ends of said elongate body;
said retainer including:
a rod slidably disposed within said axial bore of said elongate body, said rod having a first and a second end, said first end of said rod defining a cam;
a ball disposed adjacent to said cam such that when said rod is urged towards said second end of said elongate body, said cam urges said ball radially outwardly through a slot defined by said first end of said elongate body such that said elongate body is locked against removal thereof from said holes when said elongate body is in said first disposition thereof
a biasing device for urging said rod towards said second end of said elongate body; and
said extractor being secured to said second end of said rod such that when said extractor is moved towards said first end of said elongate body, said rod is moved against said biasing device towards said first end of said elongate body so that said cam permits said ball to move radially inwards to facilitate removal of said elongate body from said holes.
